(19) United States
(12) Patent Application Publication
(10) Pub. No.: US 2011/0019740 A1
(43) Pub. Date: Jan. 27, 2011

(54) Video Decoding Method

(75) Inventors: Shohei Saito, Matsudo (JP); Tomokazu Murakami, Kokubunji (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Consumer Electronics Co., Ltd., Tokyo (JP)

(21) Appl. No.: 12/788,954

(22) Filed: May 27, 2010

(30) Foreign Application Priority Data
Jul. 24, 2009 (JP) 2009-172670

(51) Int. Cl. H04N 7/32

(52) U.S. Cl. 375/240.13; 375/240.16; 375/E07.243

(57) ABSTRACT

In methods in which coding is performed by switching, per area, between a predicted image generated by an existing coding standard and an image newly generated by performing motion estimation between decoded images, it is necessary to further provide determination information as to which image is to be used, which may in some cases result in compression efficiency that is inferior to those of conventional standards depending on the input video. By determining whether a predicted image generated by an existing coding standard is to be used or an image newly generated by performing motion estimation between decoded images is to be used based on coding information within the frame to be coded or within a previously coded frame, the need for such determination information is obviated to improve compression efficiency.

### CLAIM OF PRIORITY

The present application claims priority from Japanese patent application JP 2009-172670 filed on Jul. 24, 2009, the content of which is hereby incorporated by reference into this application.

### BACKGROUND OF THE INVENTION

1. Field of the Invention

The present invention relates to a video coding technique for coding video and to a video decoding technique for decoding video.

2. Background Art

As techniques in the field, such international coding standards as MPEG (Moving Picture Experts Group) and the like have conventionally been known. There is also known a technique in which compression efficiency is improved by concurrently using, in order to further reduce image data, a predicted image generated by performing motion estimation between decoded images as well as a predicted image generated by a method similar to existing coding techniques (Patent Document 1).

[Patent Document 1] JP Patent Publication (Kokai) No. 2008-154015 A

### SUMMARY OF THE INVENTION

However, with such existing techniques, there is a need for additional determination information as to, of the predicted image generated by performing motion estimation between decoded images and the predicted image generated by a method similar to existing coding standards, based on which predicted image coding/decoding is to be performed, which, depending on the input image information, may in some cases cause compression efficiency to drop below those of conventional standards. The present invention is made in view of the problems mentioned above, and an aspect thereof is to further reduce coding bits in coding/decoding video.

In order to solve the problems mentioned above, an embodiment of the present invention may be configured as defined in the claims, for example.

With the present invention, it is possible to record and transmit video signals with fewer coding bits as compared to conventional schemes.

### BRIEF DESCRIPTION OF THE DRAWINGS

FIG. 1 is an example of a block diagram of a video coding device according to Embodiment 1.

FIG. 2 is an example of a block diagram of a coding part according to Embodiment 1.

FIG. 3 is a conceptual diagram of motion estimation using decoded images according to Embodiment 1.

FIG. 4 is a conceptual diagram of a predicted image determination process according to Embodiment 1.

FIG. 5 is an example of a block diagram of a video decoding device according to Embodiment 1.

FIG. 6 is an example of a block diagram of a decoding part according to Embodiment 1.

FIG. 7 is a flowchart of a decoding process according to embodiment 1.

FIG. 8 is a conceptual diagram of a predicted image determination process according to Embodiment 2.

FIG. 9 is a flowchart of a decoding process according to Embodiment 2.

FIG. 10 is a conceptual diagram of a predicted image determination process according to Embodiment 3.

FIG. 11 is a flowchart of a decoding process according to Embodiment 3.

FIG. 12 is a conceptual diagram of motion estimation using decoded images according to Embodiment 4.

FIG. 13 is a conceptual diagram of a predicted image determination process according to Embodiment 4.

FIG. 14 is a conceptual diagram of a predicted image determination process according to Embodiment 4.

### DESCRIPTION OF SYMBOLS

101,501: input part, 102: area segmenting part, 103: coding part, 104: variable length coding part, 201: subtractor, 202: frequency transform/quantization part, 203,603: inverse quantization/inverse frequency transform part, 204,604: adder, 205,605: decoded image storage part, 206: intra prediction part, 207: inter prediction part, 208: intra/inter predicted image determination part, 209,608: decoded image motion estimation part, 210,609: interpolated predicted image generation part, 211,607: interpolated predicted image determination part, 502: variable length decoding part, 602: syntax parsing part, 606: predicted image generation part.

### DETAILED DESCRIPTION OF THE PREFERRED EMBODIMENTS

### Embodiment 1

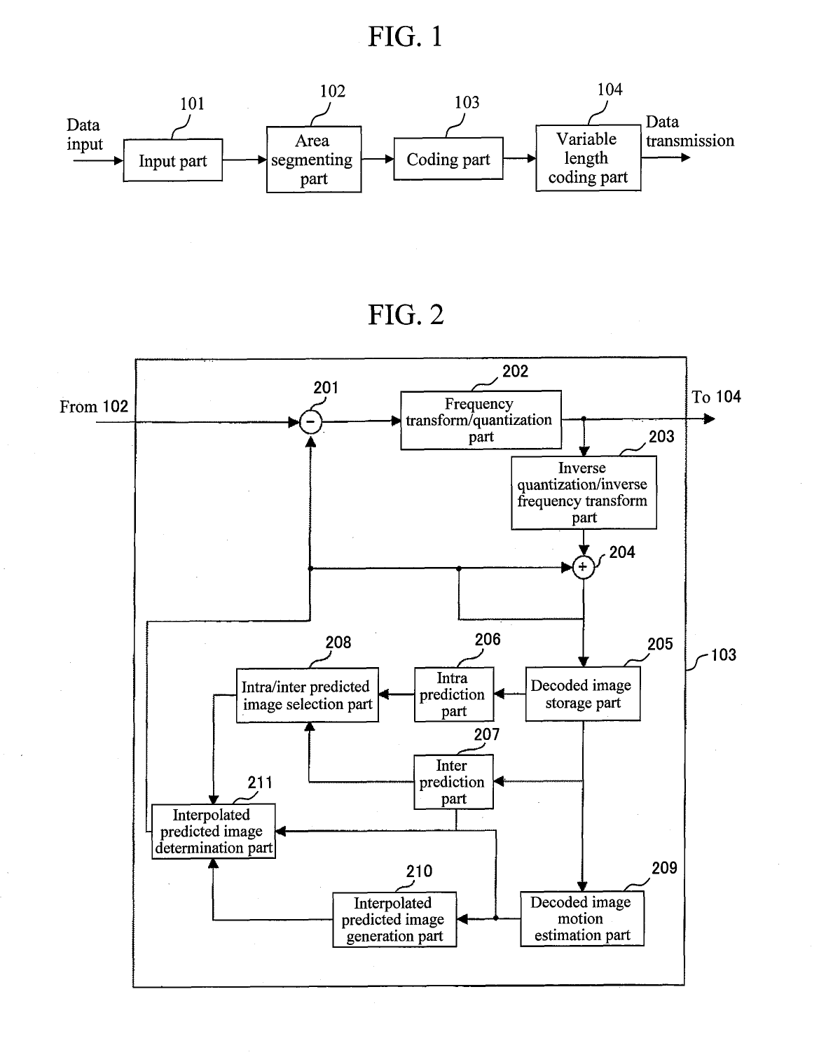

FIG. 1 shows the configuration of a video coding device according to the present embodiment.

A video coding device according to the present embodiment comprises: an input part 101 to which image data is inputted; an area segmenting part 102 that segments the inputted image data into small segments; a coding part 103 that performs a coding process and a local decoding process with respect to the image data segmented at the area segmenting part 102; and a variable length coding part 104 that performs variable length coding on the image data coded at the coding part 103.

Operations of each processing part of a video coding device according to the present embodiment will be described in further detail below.

At the input part 101, the inputted image data is rearranged in the order in which coding is to be performed. This rearrangement of the order is such that depending on which of an intra predicted picture (I picture), an inter predicted picture (P picture), and a bi-predictive picture (B picture) the pictures are, a rearrangement from order of display to order of coding is performed.

At the area segmenting part 102, a frame to be coded is segmented into small areas. The shape of the small areas into which the frame is to be segmented may be a block unit such as a square or rectangular area or it may be an object unit that is extracted using such methods as the watershed method. Further, the small areas into which the frame is to be segmented may be of a size that is adopted in existing coding standards such as 16×16 pixels, or they may be of a larger size such as 64×64 pixels.

The coding part 103 will be discussed later.

At the variable length coding part 104, variable length coding is performed on the image data coded at the coding part 103.

The coding part 103 will be described with reference to FIG. 2.

The coding part 103 comprises: a subtractor 201 that generates difference image data between the image data segmented at the area segmenting part 102 and predicted image data determined at an interpolated predicted image determination part 211; a frequency transform/quantization part 202 that performs frequency transform and quantization on the difference image data generated at the subtractor 201; an inverse quantization/inverse frequency transform part 203 that performs inverse quantization and inverse frequency transform on the image data frequency transformed and quantized at the frequency transform/quantization part 202; an adder 204 that adds the image data inverse quantized and inverse frequency transformed at the inverse quantization/inverse frequency transform part 203, and the predicted image data determined at the interpolated predicted image determination part 211; a decoded image storage part 205 that stores the image data added at the adder 204; an intra prediction part 206 that generates an intra predicted image from pixels in peripheral areas to an area to be coded; an inter prediction part 207 that generates an inter predicted image by detecting, from among areas within a frame that temporally differs from a frame to be coded, an area that best approximates the area to be coded; an intra/inter predicted image selection part 208 that selects the predicted image with a higher coding efficiency from the intra predicted image and the inter predicted image; a decoded image motion estimation part 209 that detects areas that best approximate each other in decoded images that are stored in the decoded image storage part 205 and differ temporally, and performs motion estimation; an interpolated predicted image generation part 210 that generates an interpolated predicted image based on motion information estimated at the decoded image motion estimation part 209; and the interpolated predicted image determination part 211 that determines, from among the interpolated predicted image generated at the interpolated predicted image generation part 210 and the intra predicted image or the inter predicted image selected at the intra/inter predicted image selection part 208, which predicted image is to be used as a predicted image of the area to be coded.

Operations of the various processing parts of the coding part 103 are described in further detail.

At the frequency transform/quantization part 202, the difference image is frequency transformed using DCT (Discrete Cosine Transform), wavelet transform, etc., and the coefficient after frequency transform is quantized.

At the inverse quantization/inverse frequency transform part 203, inverse processes to the processes performed at the frequency transform/quantization part 202 are performed.

Next, the image data, which has been inverse quantized and inverse frequency transformed at the inverse quantization/inverse frequency transform part 203, and the predicted image, which has been determined at the interpolated predicted image determination part 211, are added at the adder 204, and the added image data is stored at the decoded image storage part 205.

At the intra prediction part 206, the intra predicted image is generated using pixels in the areas peripheral to the decoded area to be coded stored in the decoded image storage part 205.

At the inter prediction part 207, the area that best approximates the area to be coded is detected by a matching process from among image areas within an already decoded frame stored in the decoded image storage part 205, and the image of that detected area is taken to be the inter predicted image.

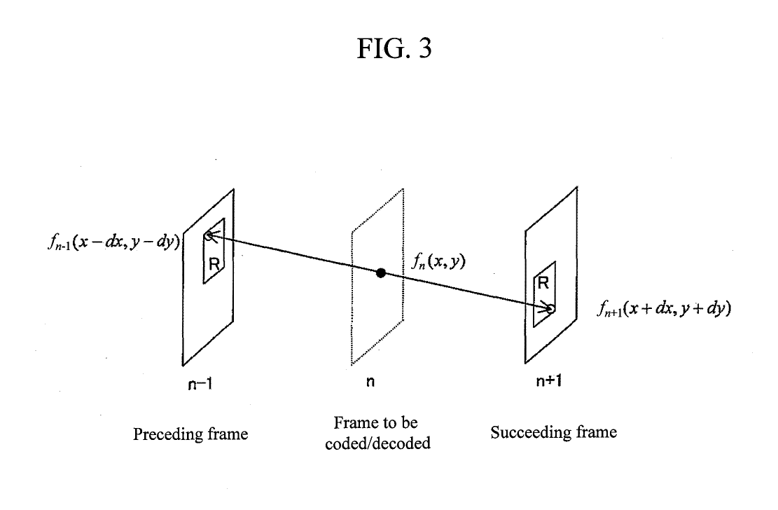

At the decoded image motion estimation part 209, the decoded images stored in the decoded image storage part 205 are subjected to the following processes. Specifically, as shown in FIG. 3, using pixels fₙ₋₁(x−dx,y−dy) and fₙ₊₁(x+dx,y+dy) in the frames that precede and succeed frameₙ, that is to be coded, the predicted Sum of Absolute Differences SADₙ(x,y) indicated in Equation 1 is calculated, where R represents area size at the time of motion estimation.

$${SAD}_{n} ( x , y ) = {\sum }_{n , m ∈ R} \vert {f}_{n - 1} ( x - dx + n , y - dy + m ) - {f}_{n + 1} ( x + dx + n , y + dy + m ) \vert \qquad [ Equation 1 ]$$

Next, coordinates (dx,dy) in the motion estimation area R for which SADₙ(x,y) in Equation 1 becomes smallest are calculated to determine a motion vector.

At the interpolated predicted image generation part 210, an interpolated predicted image is generated by the following method. Specifically, using the motion vector calculated at the decoded image motion estimation part 209, pixel fₙ(x,y) of the area to be coded is generated from the pixels fₙ₋₁(x−dx,y−dy) and fₙ₊₁(x+dx,y+dy) within the already coded frames that respectively precede and succeed the frame to be coded as indicated in Equation 2.

$${f}_{n} ( x , y ) = \frac{{f}_{n - 1} ( x - dx , y - dy ) + {f}_{n + 1} ( x + dx , y + dy )}{2} \qquad [ Equation 2 ]$$

Assuming the area to be coded is a macroblock of 16×16 pixels, the interpolated predicted image of the area to be coded is expressed by Equation 3.

$${\sum }_{x = 0 ,}^{16} {\sum }_{y = 0}^{16} {f}_{n} ( x , y ) \qquad [ Equation 3 ]$$

Next, it is determined at the interpolated predicted image determination part 211 which predicted image, of the interpolated predicted image and the intra predicted image or the inter predicted image, is to be used as the predicted image of the area to be coded.

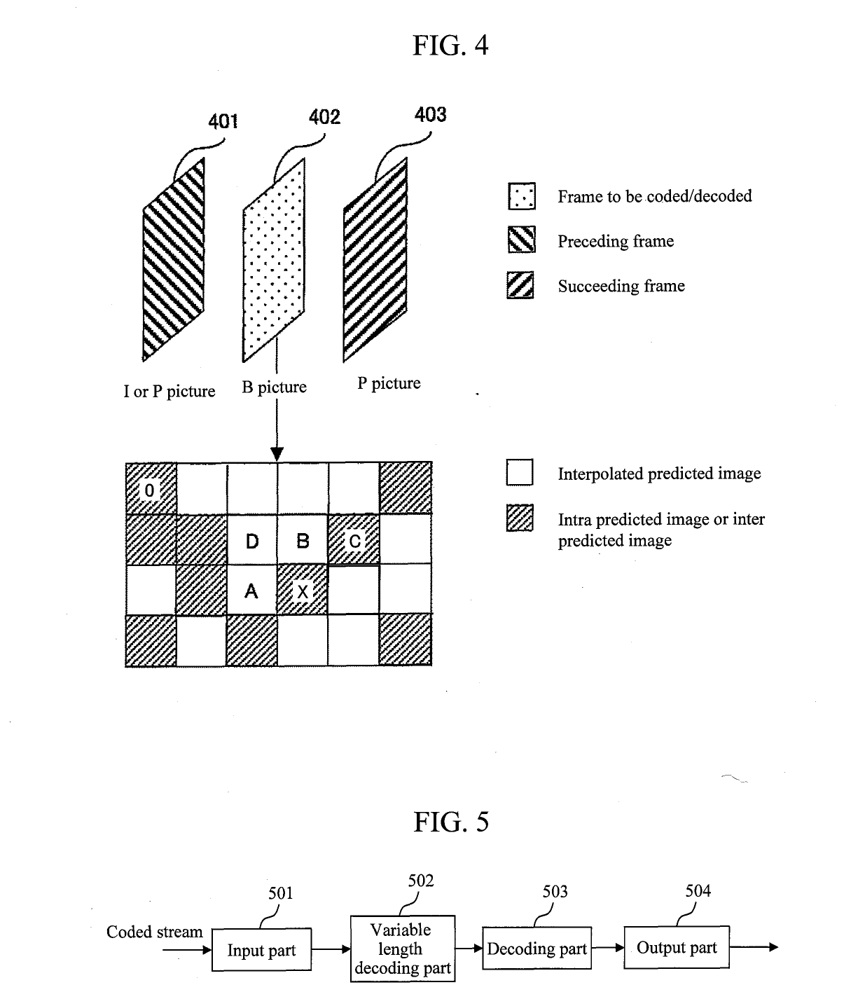

Details of the interpolated predicted image determination part 211 will be described with reference to FIG. 4. Here, FIG. 4 shows an example where areas having an interpolated predicted image and areas having an intra predicted image or an inter predicted image coexist.

First, assuming that the area to be coded is X, similarity degrees of motion vectors of areas A, B, and C (i.e., MVA, MVB, and MVC or MVD) that are peripheral to X (if the motion vector for C cannot be obtained, the motion vector of D is substituted therefor) are calculated. Here, each of the motion vectors of the areas A, B, and C that are peripheral to X is either a motion vector that is generated at the decoded image motion estimation part 209 or a motion vector that is generated at the inter prediction part 207. If the area peripheral to X is an area having an interpolated predicted image (A, B, D), the motion vector generated at the decoded image motion estimation part 209 is used. On the other hand, if the area peripheral to X is an area having an intra predicted image or an inter predicted image (C), the motion vector generated at the inter prediction part 207 is used.

As similarity degrees of the motion vectors of the areas peripheral to X, differences between the respective motion vectors of A, B, and C (|MVA−MVB|, |MVB−MVC|, |MVC−MVA|) are calculated.

If all of these differences between the motion vectors are equal to or less than threshold TH1, the motion vectors of the areas peripheral to the area X to be coded are deemed similar, and the intra predicted image or the inter predicted image is used as the predicted image of the area X to be coded.

On the other hand, if even one of the differences between the respective motion vectors of A, B, and C exceeds threshold TH1, the motion vectors of the areas peripheral to the area X to be coded are deemed dissimilar, and the interpolated predicted image is used as the predicted image of the area X to be coded.

FIG. 5 shows the configuration of a video decoding device according to the present embodiment.

A video decoding device according to the present embodiment comprises: an input part 501 that inputs a coded stream; a variable length decoding part 502 that performs a variable length decoding process with respect to the inputted coded stream; a decoding part 503 that decodes the variable length decoded image data; and an output part 504 that outputs the decoded image data.

Since the structure and operation of each processing part of a video decoding device according to the present embodiment are, with the exception of the structure and operation of the decoding part 503, similar to the structure and operation of the corresponding processing part in a video coding device according to the present embodiment, descriptions thereof are omitted herein.

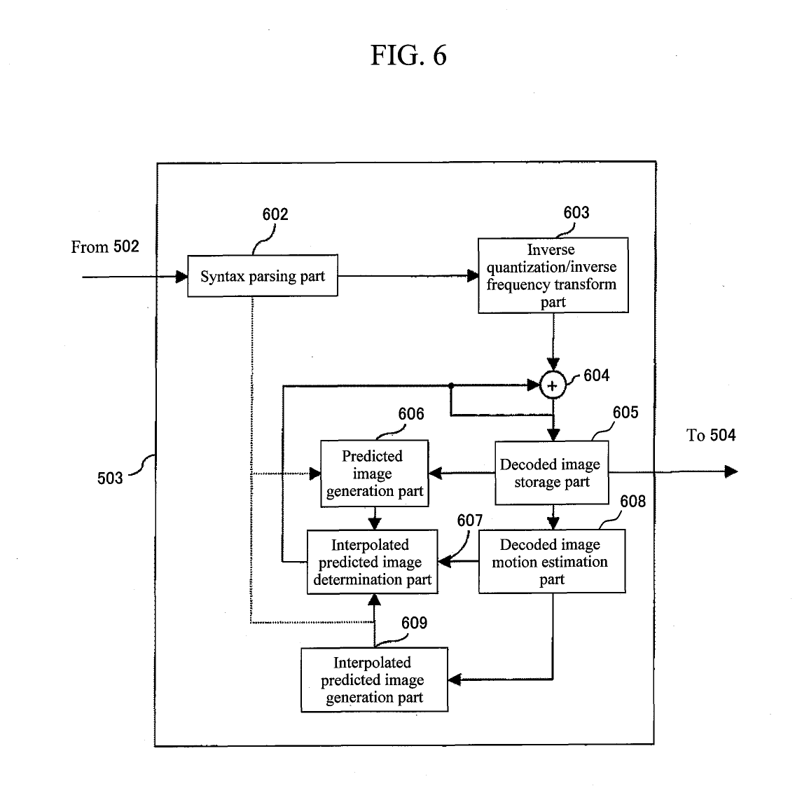

The decoding part 503 will be described with reference to FIG. 6.

The decoding part 503 comprises: a syntax parsing part 602 that performs syntax parsing of image data on which a variable length decoding process has been performed at the variable length decoding part 502; an inverse quantization/inverse frequency transform part 603 that performs inverse quantization and inverse frequency transform on the image data parsed at the syntax parsing part 602; an adder 604 that adds the image data that has been inverse quantized and inverse frequency transformed by the inverse quantization/inverse frequency transform part 603 and predicted image data determined at an interpolated predicted image determination part 607; a decoded image storage part 605 that stores the image data added at the adder 604; a predicted image generation part 606 that generates, based on coding mode information parsed at the syntax parsing part 602, either an intra predicted image using the image data stored in the decoded image storage part 605 or an inter predicted image using motion information included in the coded stream; the interpolated predicted image determination part 607 that determines, of the predicted image generated at the predicted image generation part 606 and an interpolated predicted image generated at an interpolated predicted image generation part 609 based on motion estimation performed on the decoding side, which predicted image is to be used as a predicted image of an area to be decoded; a decoded image motion estimation part 608 that detects, from decoded images stored in the decoded image storage part 605 that differ temporally from each other, areas that best approximate each other and performs motion estimation; and the interpolated predicted image generation part 609 that generates the interpolated predicted image based on motion information estimated at the decoded image motion estimation part 608.

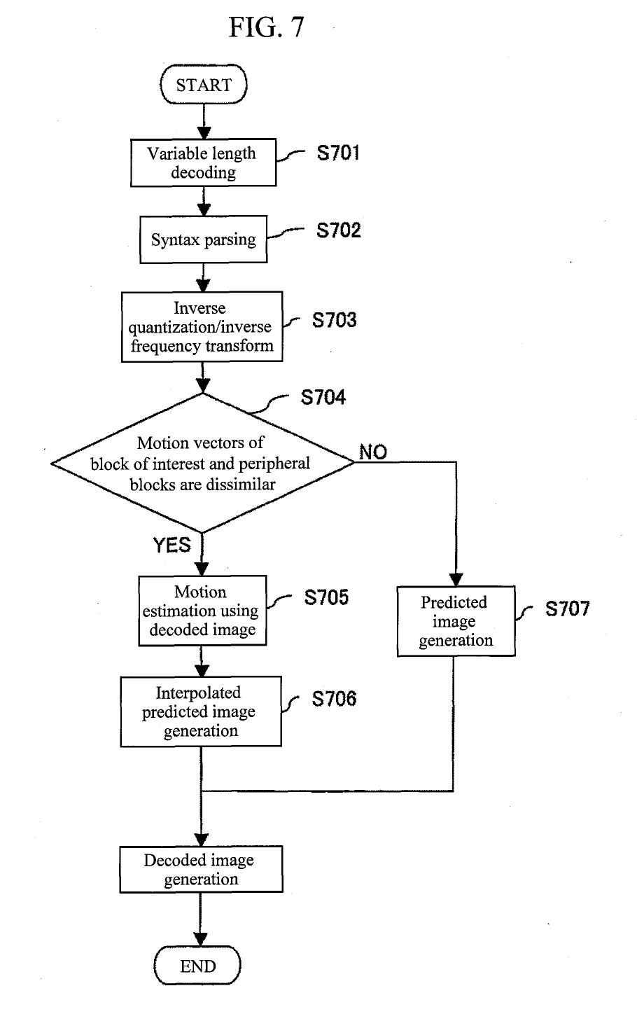

FIG. 7 shows the flow of a decoding process according to the present embodiment.

First, a variable length decoding process is performed with respect to image data included in a coded stream at the variable length decoding part 502 (S701). Next, at the syntax parsing part 602, syntax splitting of the decoded stream data is performed, and predicted difference data is sent to the inverse quantization/inverse frequency transform part 603, and motion information to the predicted image generation part 606 and the interpolated predicted image determination part 607 (S702). Next, an inverse quantization and inverse frequency transform process is performed with respect to the predicted difference data at the inverse quantization/inverse frequency transform part 603 (S703). Next, at the interpolated predicted image determination part 607, it is determined, of the interpolated predicted image based on motion estimation performed on the decoding side and the predicted image generated by an intra prediction process or by an inter prediction process using motion information included in the coded stream, which predicted image is to be used as the predicted image of the area to be decoded (S704). It is noted that this determination process may be performed by a similar method as the process by the interpolated predicted image determination part 211 on the coding side. Further, this determination process is a process that determines whether the interpolated predicted image based on motion estimation performed on the decoding side is to be used as the predicted image of the area to be decoded, or a predicted image generated by some other method is to be used as the predicted image of the area to be decoded.

If the motion vector of the area to be decoded is similar to the motion vectors of the peripheral areas to the area to be decoded, it is determined that a predicted image generated by an intra prediction process or by an inter prediction process that uses motion information included in the coded stream is to be used as the predicted image of the area to be decoded, and if they are dissimilar, it is determined that an interpolated predicted image based on motion estimation performed on the decoding side is to be used as the predicted image of the area to be decoded. Here, this determination process is performed based on the similarity degrees of motion vectors of areas that are within the same frame as the area to be decoded and that are adjacent to the area to be decoded.

If it is determined that an interpolated predicted image based on motion estimation performed on the decoding side is to be used as the predicted image of the area to be decoded, motion estimation is performed at the decoded image motion estimation part 608 by a method similar to the process by the decoded image motion estimation part 209 on the coding side (S705). Further, an interpolated predicted image is generated at the interpolated predicted image generation part 609 by a method similar to that by the interpolated predicted image generation part 210 on the coding side (S706).

On the other hand, if it is determined at the interpolated predicted image determination part 607 that a predicted image generated by an intra prediction process or by an inter prediction process that uses motion information included in the coded stream is to be used as the predicted image of the area to be decoded, an intra predicted image or an inter predicted image by an inter prediction process that uses motion information included in the coded stream is generated at the predicted image generation part 606 (S707).

In the present embodiment, since motion estimation cannot be performed on the first area in the coding/decoding process (that is, the area located at the upper left corner of the frame to be coded/decoded, or an area that is located within a predetermined range from this area and is within a motion estimation range) at the decoded image motion estimation parts 209, 608, a process similar to existing coding/decoding processes may be performed instead.

In addition, if it is determined at the interpolated predicted image determination parts 211, 607 that an interpolated predicted image is to be used as the predicted image of the area to be coded/decoded, this interpolated predicted image may also be stored in the decoded image storage parts 205, 605 as a decoded image directly. In this case, since difference data between the original image and the interpolated predicted image is not transmitted from the coding side to the decoding side, it is possible to reduce the coding bits of the difference data.

Further, although a description has been provided in the present embodiment for a case where the frame to be coded/decoded is a single B picture, it is also applicable to a case where there are a plurality of B pictures.

In addition, with respect to motion estimation, the present embodiment discusses an example of a full search. However, for the purpose of reducing processing volume, a simplified motion estimation method may also be used. In addition, a plurality of motion estimation methods may be prepared in advance on the encoder and decoder sides, and it may be transmitted by means of a flag, etc. which estimation method was used. A motion estimation method may also be selected in accordance with such information as level, profile, etc. The same applies to the estimation range, where the estimation range may be transmitted, a flag may be transmitted with a plurality thereof prepared in advance, or a selection may be made depending on the level, profile, etc.

In addition, by creating a program in which are recorded the steps for executing the coding/decoding process in the present embodiment, it may be run on a computer. It is noted that a program that executes such a coding/decoding process may be downloaded and used by a user via a network such as the Internet and the like. In addition, it may be recorded on a recording medium and used as such. In addition, it may be applied to a wide range of recording media, examples of which include optical disks, magneto-optical disks, hard disks, and the like.

Here, the similarity degree in the present embodiment may also be calculated based on the variance of the motion vectors of a plurality of already coded/decoded areas that are adjacent to the area of interest.

In addition, the present embodiment may be combined with other embodiments.

Thus, according to the present embodiment, it becomes unnecessary to transmit from the coding side to the decoding side information for determining, of the interpolated predicted image and the intra predicted image or the inter predicted image, which predicted image is to be used as the predicted image of the area to be coded/decoded in performing the coding/decoding process, thereby allowing for an improvement in compression efficiency.

### Embodiment 2

In Embodiment 1, the determination process for the predicted image of the area to be coded/decoded was performed at the interpolated predicted image determination parts 211, 607 of the coding part 103 and the decoding part 503, using similarity degrees of motion vectors. In the present embodiment, the determination process for the predicted image of the area to be coded/decoded is performed in accordance with, in place of the similarity degrees of motion vectors, the number of areas peripheral to the area to be coded/decoded that have an interpolated predicted image.

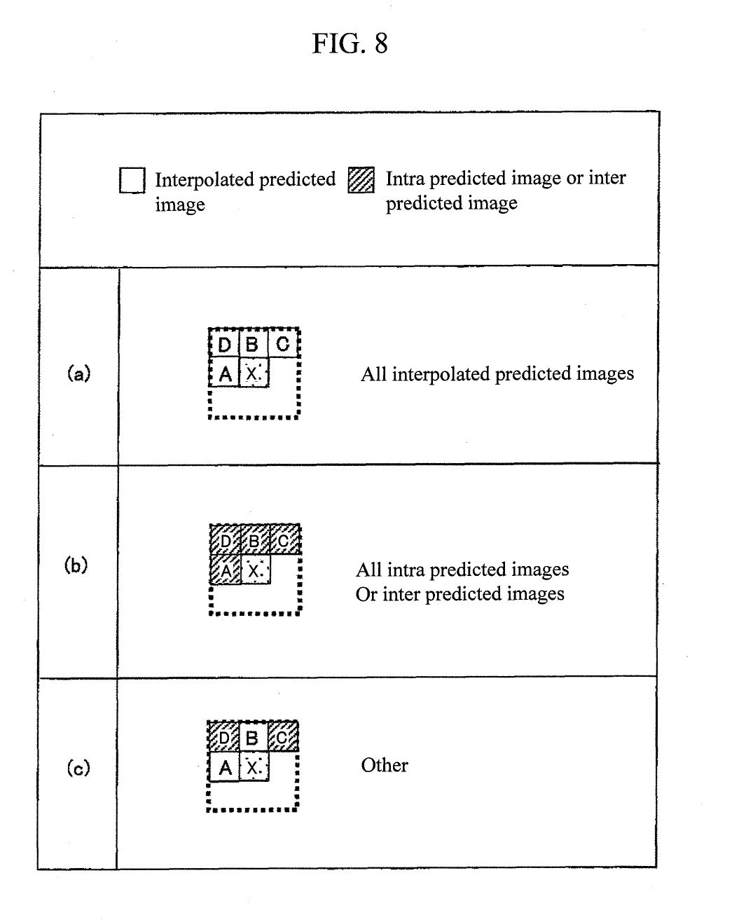

A determination process by an interpolated predicted image determination part in a video coding device and video decoding device according to the present embodiment will be described with reference to FIG. 8. It is noted that since the structures and operations of a video coding device and video decoding device according to the present embodiment are, with the exception of the structure and operation of the interpolated predicted image determination part, similar to the structures and operations of the video coding device and video decoding device according to Embodiment 1, descriptions thereof are omitted herein.

FIG. 8 shows an example of a distribution chart indicating whether the predicted images of peripheral areas (A, B, C, D) to area X to be coded/decoded are interpolated predicted images, or intra predicted images or inter predicted images. First, if all of the predicted images of the areas peripheral to the area to be coded/decoded are interpolated predicted images (FIG. 8(a)), it is determined at the interpolated predicted image determination part that an interpolated predicted image is to be used as the predicted image of the area to be coded/decoded. This is because there is a strong likelihood that the predicted image of the area of interest is an interpolated predicted image as well.

On the other hand, if all of the predicted images of the areas peripheral to the area to be coded/decoded are intra predicted images or inter predicted images (FIG. 8(b)), it is determined at the interpolated predicted image determination part that an intra predicted image or an inter predicted image is to be used as the predicted image of the area to be coded/decoded. This is because there is a strong likelihood that the predicted image of the area to be coded/decoded is an intra predicted image or an inter predicted image as well.

In all other cases (FIG. 8(c)), it is determined that, of the predicted images of the peripheral areas A, B, C (if there is no C, D is substituted therefor), the predicted image that is present in a greater number is to be used as the predicted image of the area to be coded/decoded. For example, in the example shown in FIG. 8(c), there are two areas (A, B) that have an interpolated predicted image and one area (C) that has an intra predicted image or an inter predicted image. It is therefore determined that an interpolated predicted image is to be used as the predicted image of area X to be coded/decoded.

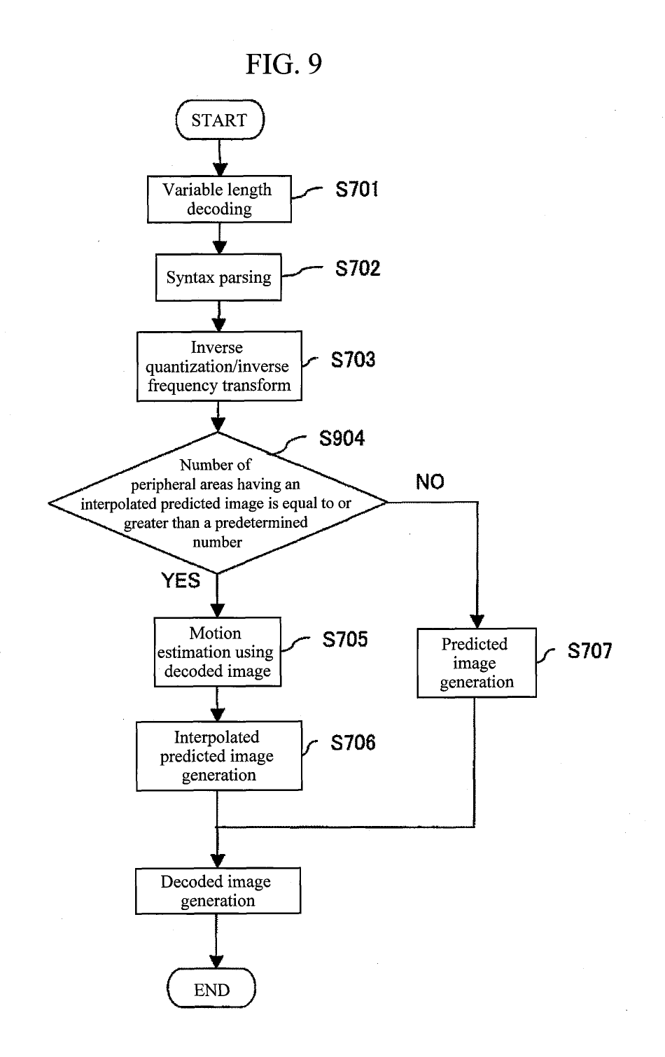

FIG. 9 is a diagram showing the flow of a decoding process according to Embodiment 2.

In a decoding process according to the present embodiment, in place of the determination process based on the similarity degrees of motion vectors of Embodiment 1 (S704) between an interpolated predicted image based on motion estimation performed on the decoding side and a predicted image generated by an intra prediction process or by an inter prediction process that uses motion information included in the coded stream, there is performed a determination process (S904) that is based on the number of areas peripheral to the area to be decoded that have an interpolated predicted image that is based on motion estimation performed on the decoding side. Since, the processes other than the determination process of S904 are similar to those in the decoding process presented in Embodiment 1, descriptions thereof are herein omitted. It is noted that this determination process is a process that determines whether an interpolated predicted image based on motion estimation performed on the decoding side is to be used as the predicted image of the area to be decoded, or a predicted image generated by some other method is to be used as the predicted image of the area to be decoded.

In the determination process of S904, if all of the predicted images of the areas peripheral to the area to be decoded are interpolated predicted images based on motion estimation performed on the decoding side, it is determined at the interpolated predicted image determination part that an interpolated predicted image is to be used. This is because there is a strong likelihood that the predicted image of the area to be decoded is an interpolated predicted image as well.

On the other hand, if all of the predicted images of the areas peripheral to the area to be decoded are predicted images generated by an intra prediction process or by an inter prediction process that uses motion information included in the coded stream, it is determined at the interpolated predicted image determination part that a corresponding predicted image is to be used. This is because there is a strong likelihood that the area to be decoded is a predicted image generated by an intra prediction process or by an inter prediction process that uses motion information included in the coded stream as well.

In all other cases, it is determined at the interpolated predicted image determination part that, of the predicted images of the peripheral areas A, B, C (if there is no C, D is substituted therefor), the predicted image that is present in a greater number is to be used as the predicted image of the area to be decoded. This is because there is a strong likelihood that the area to be decoded is that predicted image as well.

Here, up to the point where the peripheral areas A, B, and C are obtained in the present embodiment, the process for determining a predicted image may be performed by a method similar to that in Embodiment 1 or by some other method.

In addition, in the present embodiment, if it is determined at the interpolated predicted image determination part that an interpolated predicted image is to be used as the predicted image of the area to be coded/decoded, that interpolated predicted image may also be stored in the decoded image storage parts 205, 605 as the decoded image directly. In this case, since difference data between the original image and the interpolated predicted image is not transmitted from the coding side to the decoding side, it is possible to reduce the coding bits of the difference data.

Further, in the present embodiment, since motion estimation cannot be performed on the first area in the coding/decoding process (that is, the area located at the upper left corner of the frame to be coded/decoded, or an area that is located within a predetermined range from this area and is within a motion estimation range) at the decoded image motion estimation parts 209, 608, a coding/decoding process similar to existing coding/decoding processes may be performed instead.

In addition, although a description has been provided in the present embodiment for a case where the frame to be coded/decoded is a single B picture, it is also applicable to a case where there are a plurality of B pictures.

Further, with respect to motion estimation, the present embodiment discusses an example of a full search. However, for the purpose of reducing processing volume, a simplified motion estimation method may also be used. In addition, a plurality of estimation methods may be prepared in advance on the encoder and decoder sides, and it may be transmitted by means of a flag, etc. which estimation method was used. A motion estimation method may also be selected in accordance with such information as level, profile, etc. The same applies to the estimation range, where the estimation range may be transmitted, a flag may be transmitted with a plurality thereof prepared in advance, or a selection may be made depending on the level, profile, etc.

Further, by creating a program in which are recorded the steps for executing the coding/decoding process in the present embodiment, it may be run on a computer. It is noted that a program that executes such a coding/decoding process may be downloaded and used by a user via a network such as the Internet and the like. In addition, it may be recorded on a recording medium and used as such. In addition, it may be applied to a wide range of recording media, examples of which include optical disks, magneto-optical disks, hard disks, and the like.

In addition, the present embodiment may be combined with other embodiments.

Thus, according to the present embodiment, it becomes unnecessary to transmit from the coding side to the decoding side information for determining, of the interpolated predicted image and the intra predicted image or the inter predicted image, which predicted image is to be used as the predicted image of the area to be coded/decoded, thereby allowing for an improvement in compression efficiency. Further, since a determination is made as to, of the interpolated predicted image and the intra predicted image or the inter predicted image, which predicted image is to be used as the predicted image of the area to be coded/decoded in accordance with, instead of the similarity degrees of motion vectors, the number of areas peripheral to the area to be coded/decoded that have an interpolated predicted image, it is possible to perform a coding/decoding process more favorably.

### Embodiment 3

In Embodiments 1 and 2, a determination process with respect to the predicted image of the area to be coded/decoded was performed at the interpolated predicted image determination part based on the similarity degrees of the motion vectors of the areas peripheral to the area to be coded/decoded or based on the number of areas peripheral to the area to be coded/decoded that have an interpolated predicted image. In the present embodiment, a determination process with respect to the predicted image of the area to be coded/decoded is performed using coding information of an already coded/decoded frame other than the frame to be coded/decoded. More specifically, a determination process is performed using similarity degrees of motion vectors of an area within an already coded/decoded frame that is temporally distinct from the frame in which the area to be coded/decoded is present, the area (hereinafter referred to as an anchor area) being located at the same coordinates as the area to be coded/decoded, and areas that are adjacent to this area.

It is noted that since the structures and operations of a video coding device and video decoding device according to the present embodiment are, with the exception of the interpolated predicted image determination part, similar to the structures and operations of the video coding devices and video decoding devices in Embodiments 1 and 2, descriptions thereof are herein omitted.

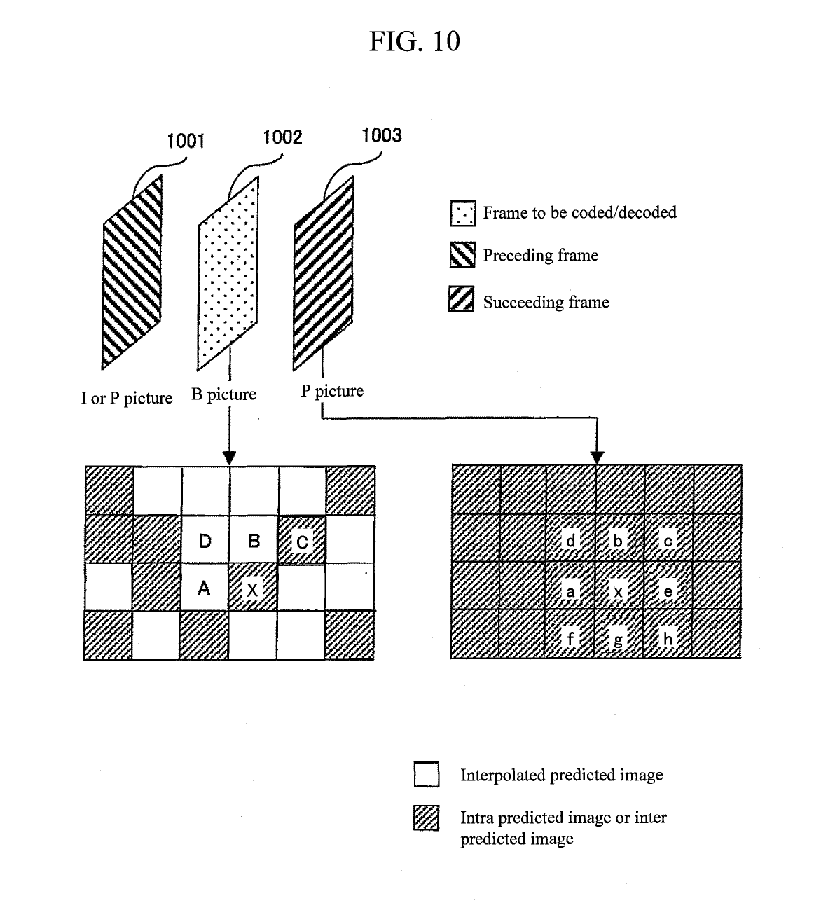

The determination process of the interpolated predicted image determination part of a video coding device and video decoding device according to the present embodiment is described with reference to FIG. 10 and Table 1.

FIG. 10 is a diagram showing the positional relationship among a frame to be coded/decoded, preceding/succeeding frames thereof, and their picture types. In the present embodiment, it is assumed that the succeeding frame is coded/decoded entirely with intra predicted images or inter predicted images.

In addition, Table 1 summarizes the relationship between the coding mode of the anchor area and the predicted image of the area to be coded/decoded.

TABLE 1

| | Motion vectors | |
|---|---|---|
| Coding mode of | in the periphery | Predicted image of area |
| anchor area | of anchor area | to be coded/decoded |
| Intra prediction mode | — | Interpolated predicted image |
| Inter prediction mode | Similar | Intra/inter predicted image |
| Inter prediction mode | Dissimilar | Interpolated predicted image |

First, the coding mode type of the anchor area is determined.

If the coding mode of the anchor area is intra prediction mode, it is determined at the interpolated predicted image determination part that an interpolated predicted image is to be used as the predicted image of the area to be coded/decoded. This is because when the motion vector of the area to be coded/decoded is predicted using the motion vector of the anchor area, prediction accuracy for motion vectors drops as the motion vector of the anchor area would be 0 when the coding mode is intra prediction, and consequently because it is more advantageous to select the above-mentioned interpolated predicted image which is generated using motion vectors obtained by performing motion estimation between decoded images.

On the other hand, if the coding mode of the anchor area is not intra prediction mode, it is determined based on motion vectors of peripheral areas to the anchor area whether the predicted image of the area to be coded/decoded is to be an interpolated predicted image or one of an intra predicted image and an inter predicted image.

For example, the respective differences (mva−mvx, mvb−mvx . . . , mvh−mvx) between motion vector mvx of anchor area x and the respective motion vectors (mva, mvb . . . , mvh) of the areas peripheral thereto (a, b . . . , h) shown in FIG. 10 are calculated. If half or more of the areas have a motion vector difference that is equal to or below threshold TH1, the motion vector mvx of the anchor area x and the motion vector of each of the peripheral areas are deemed similar, and the motion vector of the area X of interest located at the same coordinates as the anchor area in the frame to be coded/decoded and the motion vectors of the areas peripheral thereto are deemed similar. In this case, at the interpolated predicted image determination part, an intra predicted image or an inter predicted image is determined as being the predicted image of the area to be coded/decoded.

Further, if the coding mode of the anchor area is not intra prediction mode and only half or fewer of the areas are such that the difference between the motion vector mvx of the anchor area and the motion vector of each of the peripheral areas is equal to or less than threshold TH1, the motion vector mvx of the anchor area x and the motion vector of each of the peripheral areas are deemed dissimilar, and the motion vector of the area X to be coded/decoded which is located at the same coordinates as the anchor area but in the frame to be coded/decoded and the motion vectors of the peripheral areas thereto are deemed dissimilar. In this case, at the interpolated predicted image determination part, an interpolated predicted image is determined as being the predicted image of the area to be coded/decoded.

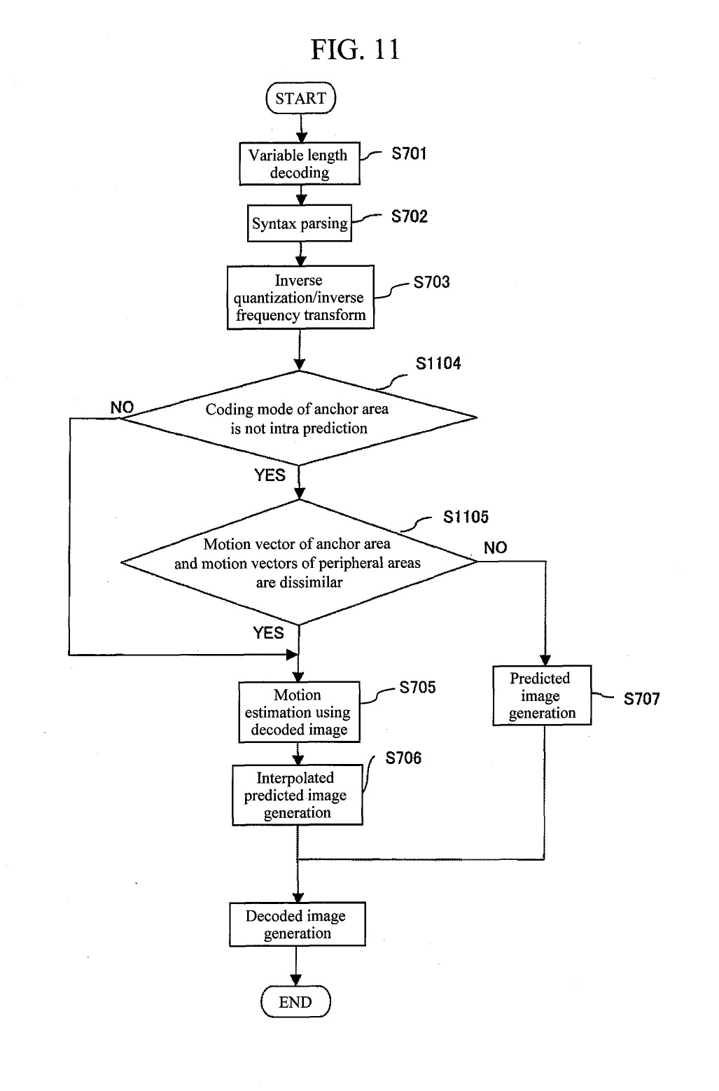

FIG. 11 is a diagram showing the flow of a decoding process according to Embodiment 3.

A decoding process according to the present embodiment comprises, in place of the determination process (S704) at the interpolated predicted image determination part in Embodiment 1 that is based on the similarity degrees of the motion vectors of the areas peripheral to the area to be coded/decoded, a determination step as to whether or not the coding mode of the anchor area is intra prediction mode (S1104), and a determination step as to whether or not the motion vector of the anchor area and the motion vectors of the peripheral areas thereto are similar (S1105). Since the processes other than the determination processes of S1104 and S1105 are similar to the processes discussed in Embodiment 1, descriptions thereof are herein omitted. It is noted that these determination processes are processes that determine whether an interpolated predicted image based on motion estimation performed on the decoding side is to be used as the predicted image of the area to be decoded, or a predicted image generated by some other method is to be used as the predicted image of the area to be decoded.

First, the coding mode type of the anchor area is determined (S1104).

If the coding mode of the anchor area is intra prediction mode, it is determined that an interpolated predicted image based on motion estimation performed on the decoding side is to be used as the predicted image of the area to be decoded, and the motion vector estimation process is performed (S705).

If the coding mode of the anchor area is not intra prediction mode, it is determined at S1105 whether or not the motion vector of the anchor area and the motion vectors of the peripheral areas to the anchor area are similar. This determination process may be performed by the determination methods discussed above.

If it is determined that the motion vector of the anchor area and the motion vectors of the areas peripheral to the anchor area are similar, it is determined that a predicted image generated by an intra prediction process or by an inter prediction process that uses motion information included in the coded stream is to be used as the predicted image of the area to be decoded, and the predicted image is generated at S707.

If it is determined that the motion vector of the anchor area and the motion vectors of the peripheral areas to the anchor area are dissimilar, it is determined that an interpolated predicted image based on motion estimation performed on the decoding side is to be used as the predicted image of the area to be decoded, and the motion vector estimation process is performed (S705).

In the example above, in the process by the interpolated predicted image determination part, similarity degrees were calculated based on differences between the motion vector of the anchor area and the motion vectors of the peripheral areas thereto to determine the predicted image of the area to be coded/decoded. However, similarity degrees may also be calculated using the variance of the motion vectors of the anchor area x and the peripheral areas thereto to determine the predicted image of the area to be coded/decoded. More specifically, the variance of the motion vectors of the anchor area and the peripheral areas thereto (mva, mvb . . . , mvh) may be calculated, and if the variance is equal to or less than threshold TH2 for half or more of the areas, the similarity degree between the motions of the area X to be coded and the peripheral areas thereto may be deemed high, and it may be determined at the interpolated predicted image determination part that an intra predicted image or an inter predicted image is to be used as the predicted image of the area to be coded/decoded.

On the other hand, if the variance of each motion vector of the anchor area and the peripheral areas thereto is equal to or less than threshold TH2 for only half or fewer of the areas, the similarity degree between the motion vectors of the area X to be coded/decoded and the peripheral areas thereto may be deemed low, and it may be determined at the interpolated predicted image determination part that an interpolated predicted image is to be used as the predicted image of the area to be coded/decoded.

In the present embodiment, if at the interpolated predicted image determination part it is determined that an interpolated predicted image is to be used as the predicted image of the area to be coded/decoded, that interpolated predicted image may also be stored in the decoded image storage parts 205, 605 as the decoded image directly. In this case, since difference data between the original image and the interpolated predicted image is not transmitted from the coding side to the decoding side, it is possible to reduce the coding bits of the difference data.

In addition, in the present embodiment, since motion estimation cannot be performed on the first area in the coding/decoding process (that is, the area located at the upper left corner of the frame to be coded/decoded, or an area that is located within a predetermined range from this area and is within a motion estimation range) at the decoded image motion estimation parts 209, 608, a coding/decoding process similar to existing coding/decoding processes may be performed instead.

In addition, although a description has been provided in the present embodiment for a case where the frame to be coded/decoded is a single B picture, it is also applicable to a case where there are a plurality of B pictures.

Further, with respect to motion estimation, the present embodiment discusses an example of a full search. However, for the purpose of reducing processing volume, a simplified motion estimation method may also be used. In addition, a plurality of estimation methods may be prepared in advance on the encoder and decoder sides, and it may be transmitted by means of a flag, etc. which estimation method was used. A motion estimation method may also be selected in accordance with such information as level, profile, etc. The same applies to the estimation range, where the estimation range may be transmitted, a flag may be transmitted with a plurality thereof prepared in advance, or a selection may be made depending on the level, profile, etc.

Further, by creating a program in which are recorded the steps for executing the coding/decoding process in the present embodiment, it may be run on a computer. It is noted that a program that executes such a coding/decoding process may be downloaded and used by a user via a network such as the Internet and the like. In addition, it may be recorded on a recording medium and used as such. In addition, it may be applied to a wide range of recording media, examples of which include optical disks, magneto-optical disks, hard disks, and the like.

In addition, the present embodiment may be combined with other embodiments.

Thus, according to the present embodiment, since it is possible to determine which of an interpolated predicted image and an intra predicted image or an inter predicted image is to be the predicted image of the area to be coded/decoded without using coding/decoding information of the frame to be coded/decoded, it becomes possible to perform the predicted image determination process even in cases where the coding/decoding information for the periphery of the area to be coded/decoded cannot be obtained due to hardware pipelining and the like.

### Embodiment 4

In Embodiments 1-3, descriptions were provided with respect to examples where the frame of interest is a B picture. In the present embodiment, there will be described an example where the frame of interest is a P picture. Since the structures and operations of a video coding device and video decoding device according to the present embodiment are, with the exception of the structures and operations of the decoded image motion estimation part, the interpolated predicted image generation part and the interpolated predicted image determination part, similar to the those of the video coding device and video decoding device according to Embodiment 1, descriptions thereof are omitted herein. It is noted that the process of determining the predicted image in the present embodiment is, as in Embodiments 1-3, a process that determines whether an interpolated predicted image is to be used as the predicted image of the area to be coded/decoded, or a predicted image generated by some other method is to be used as the predicted image of the area to be coded/decoded.

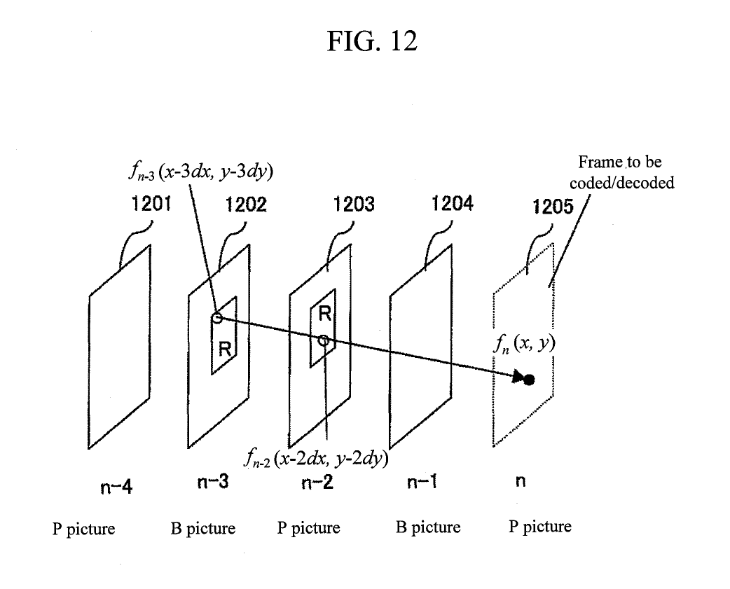

FIG. 12 illustrates an interpolated image generation method for P picture 1205.

First, the predicted Sum of Absolute Differences SADₙ(x,y) indicated in Equation 4 of the two frames (1202, 1203) immediately preceding the frame of interest (1205) is calculated. Specifically, pixel value fₙ₋₂(x−2dx,y−2dy) in the preceding frame 1203 and pixel value fₙ₋₃(x−3dx,y−3dy) in the twice preceding frame 1202 are used. Here, R represents the area size at the time of motion estimation.

$${SAD}_{n} ( x , y ) = {\sum }_{i , j ∈ R} \vert {f}_{n - 2} ( x - 2 dx + i , y - 2 dx + j ) - {f}_{n - 3} ( x - 3 dx + i , y - 3 dx + j ) \vert \qquad [ Equation 4 ]$$

Here, the pixel in the preceding frame 1203 and the pixel in the twice preceding frame 1202 are so determined as to lie on a straight line on which the pixel to be interpolated in the succeeding frame 1205 lies in a spatio-temporal coordinate system.

Next, coordinates (dx,dy) within a motion estimation area R for which Equation 4 gives the smallest value are calculated to determine the motion vector.

At the interpolated predicted image generation part, an interpolated predicted image is generated by a method that will be described later. Specifically, using the motion vector (dx,dy) calculated at the decoded image motion estimation part, pixel fₙ(x,y) in the area of interest is generated through extrapolation from pixels fₙ₋₂(x−2dx,y−2dy) and fₙ₋₃(x−3dx,y−3dy) in already coded/decoded frames that precede the frame of interest as in Equation 5.

fₙ(x,y)=3fₙ₋₂(x−2dx,y−2dy)−2fₙ₋₃(x−3dx,y−3dy) [Equation 5]

When the area of interest is a macroblock of 16×16 pixels, the interpolated image of the anchor area is expressed by Equation 6.

$${\sum }_{x = 0 ,}^{16} {\sum }_{y = 0}^{16} {f}_{n} ( x , y ) \qquad [ Equation 6 ]$$

The determination between an interpolated predicted image and an intra predicted image or inter predicted image may be performed by a method similar to those of Embodiments 1-3.

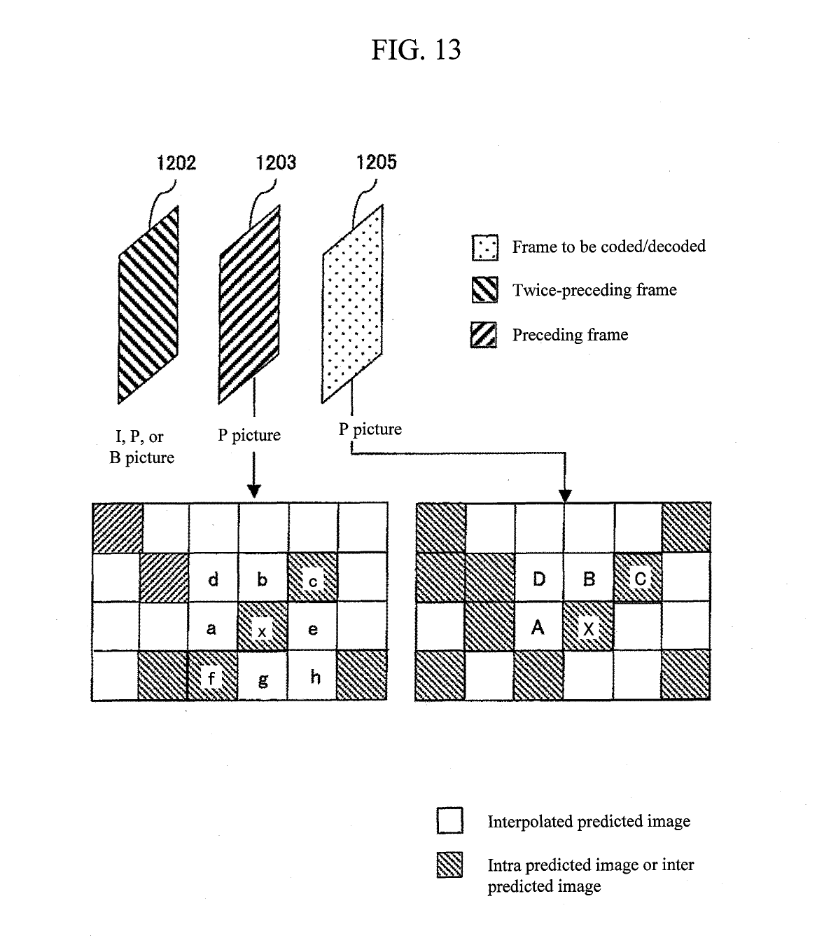

The process by the interpolated predicted image determination part in the present embodiment in a case where the frame of interest is a P picture will now be described with reference to FIG. 13. In addition, the relationship between the coding mode of the anchor area and the predicted image of the area of interest in the present embodiment is summarized in Table 2.

TABLE 2

| | Number of interpolated | |
|---|---|---|
| Coding mode of | predicted images in the | Predicted image of |
| anchor area | periphery of anchor area | area to be coded |
| Intra prediction mode | — | Interpolated predicted |
| | | image |
| Inter prediction mode | Half or more | Interpolated predicted |
| | | image |
| Inter prediction mode | Half or fewer | Intra/inter predicted |
| | | image |

FIG. 13 is a diagram showing an example of the area distribution of interpolated predicted images and intra predicted images or inter predicted images in the frame of interest and a preceding frame. Assuming that the area to be coded/decoded in the frame to be coded/decoded is X, area x (anchor area) in the preceding frame would be that which is located at the same position spatially.

First, in the present embodiment, the coding mode type of the anchor area is determined. For example, if the coding mode of the anchor area is intra prediction mode, it is determined at the interpolated predicted image determination part that an interpolated predicted image is to be used as the predicted image of the area to be coded/decoded. The reason therefor is the same as that in Embodiment 3.

On the other hand, if the anchor area is not an intra predicted image, it is determined based on motion vectors of the anchor area and the peripheral areas thereto which of an interpolated predicted image and an intra predicted image or inter predicted image is to be used as the predicted image of the area to be coded/decoded. For example, the respective differences (mva−mvx, mvb−mvx . . . , mvh−mvx) between motion vector mvx of anchor area x and the respective motion vectors (mva, mvb . . . , mvh) of the areas peripheral thereto (a, b . . . , h) shown in FIG. 13 are calculated. If half or more of the areas have a motion vector difference that is equal to or below threshold TH1, it is determined at the interpolated predicted image determination part that an intra predicted image or inter predicted image is to be used as the predicted image of the area to be coded/decoded.

On the other hand, if only half or fewer of the areas are such that the difference between the motion vectors of the anchor area and of the peripheral area is equal to or less than threshold TH1, it is determined at the interpolated predicted image determination part that an interpolated predicted image is be used as the predicted image of the area to be coded/decoded.

Next, there will be described a method of determining whether the predicted image of the area to be coded/decoded is to be an interpolated predicted image or one of an intra predicted image and an inter predicted image based on the anchor area and the number of areas peripheral to the anchor area that have an interpolated predicted image.

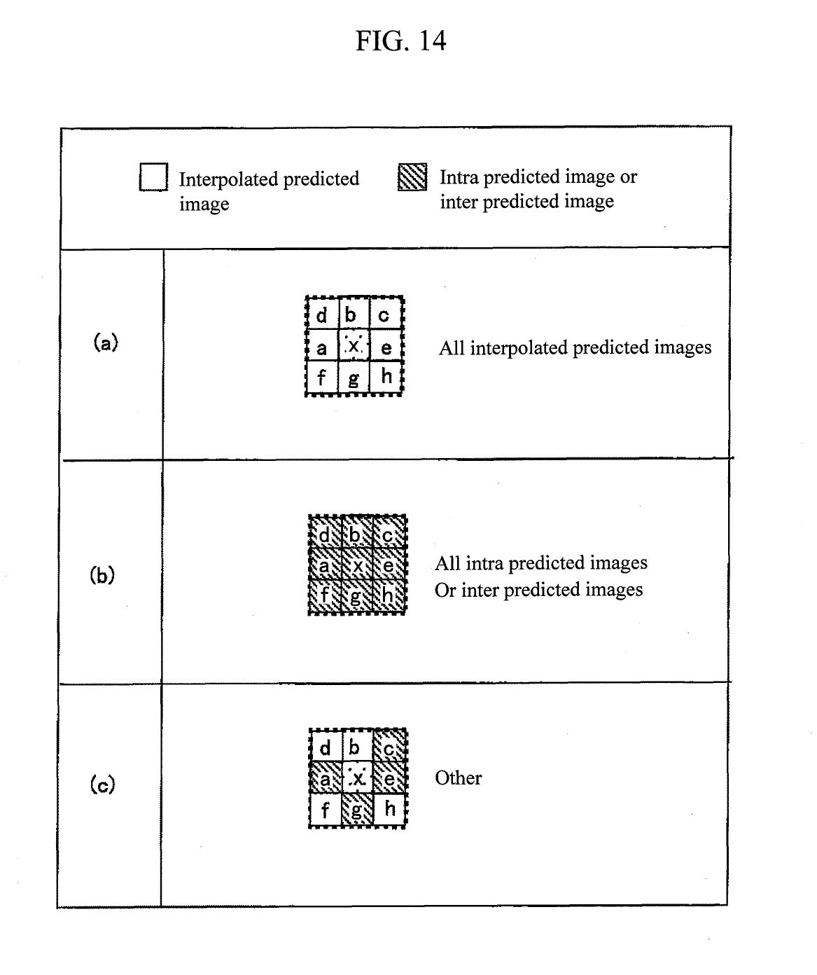

A distribution example of predicted images in the anchor area and its periphery in the present embodiment is shown in FIG. 14.

If the anchor area and all of its peripheral areas are interpolated predicted images (FIG. 14(a)), an interpolated predicted image is taken to be the predicted image of the area to be coded/decoded. This is because since interpolated predicted images are generated by performing motion estimation between decoded images that precede and succeed the area to be coded/decoded, when the periphery of the anchor area is entirely interpolated predicted images, there is a strong likelihood that the area to be coded/decoded is an interpolated predicted image as well.

On the other hand, if the anchor area and all of its peripheral areas are intra predicted images or inter predicted images (FIG. 14(b)), an intra predicted image or an inter predicted image is taken to be the predicted image of the area to be coded/decoded. This is because when not all of the predicted images of the areas peripheral to the anchor area are interpolated predicted images, the likelihood that the predicted image of the area to be coded/decoded would be an interpolated predicted image is low.

In all other cases (FIG. 14(c)), the most frequently found predicted image among the anchor area x and its peripheral areas (a, b . . . , h) is taken to be the predicted image of the area to be coded/decoded.

It is noted that in the process of the interpolated predicted image determination part, the variance of the motion vectors of the anchor area and its peripheral areas may also be used as in Embodiment 3.

In addition, in the present embodiment, if it is determined at the interpolated predicted image determination part that an interpolated predicted image is to be used as the predicted image of the area to be coded/decoded, that interpolated predicted image may also be stored in the decoded image storage parts 205, 605 as a decoded image directly. In this case, since difference data between the original image and the interpolated predicted image is not transmitted from the coding side to the decoding side, it is possible to reduce the coding bits of the difference data.

Further, in the present embodiment, since motion estimation cannot be performed on the first area in the coding/decoding process (that is, the area located at the upper left corner of the frame to be coded/decoded, or an area that is located within a predetermined range from this area and is within a motion estimation range) at the decoded image motion estimation parts 209, 608, a coding/decoding process similar to existing coding/decoding processes may be performed instead.

In addition, with respect to motion estimation, the present embodiment discusses an example of a full search. However, for the purpose of reducing processing volume, a simplified motion estimation method may also be used. In addition, a plurality of motion estimation methods may be prepared in advance on the encoder and decoder sides, and it may be transmitted by means of a flag, etc. which estimation method was used. A motion estimation method may also be selected in accordance with such information as level, profile, etc. The same applies to the estimation range, where the estimation range may be transmitted, a flag may be transmitted with a plurality thereof prepared in advance, or a selection may be made depending on the level, profile, etc.

Further, by creating a program in which are recorded the steps for executing the coding/decoding process in the present embodiment, it may be run on a computer. It is noted that a program that executes such a coding/decoding process may be downloaded and used by a user via a network such as the Internet and the like. In addition, it may be recorded on a recording medium and used as such. In addition, it may be applied to a wide range of recording media, examples of which include optical disks, magneto-optical disks, hard disks, and the like.

In addition, the present embodiment may be combined with other embodiments.

Thus, the present embodiment allows for a more accurate process for making a determination between an interpolated predicted image and an intra predicted image or inter predicted image.

1. A video decoding method, comprising:
an input step of inputting a coded stream;
a generation step of decoding the coded stream and generating decoded image data; and
an output step of outputting the decoded image data, wherein
in the generation step, based on a similarity degree among motion vectors of a plurality of predetermined areas that are already decoded, it is determined per area whether a decoding process is to be performed using a predicted image generated by an intra prediction process or by an inter prediction process that uses motion information included in the coded stream, or the decoding process is to be performed using an interpolated predicted image generated by performing, on a decoding side, motion vector estimation among a plurality of already decoded frames and performing interpolation based on the motion vector estimation.

2. The video decoding method according to claim 1, wherein the plurality of predetermined areas that are already decoded are a plurality of areas that are within the same frame as an area to be decoded and that are adjacent to the area to be decoded.

3. The video decoding method according to claim 1, wherein the plurality of predetermined areas that are already decoded are areas within an already decoded frame that is temporally distinct from a frame in which an area to be decoded is present, and comprise an area that is located at the same coordinates as the area to be decoded, and areas adjacent to the area that is located at the same coordinates as the area to be decoded.

4. A video decoding method, comprising:
an input step of inputting a coded stream;
a generation step of decoding the coded stream and generating decoded image data; and
an output step of outputting the decoded image data, wherein
in the generation step, based on, of a plurality of predetermined areas that are already decoded, the number of areas that have an interpolated predicted image, it is determined per area whether a decoding process is to be performed using a predicted image generated by an intra prediction process or by an inter prediction process that uses motion information included in the coded stream, or the decoding process is to be performed using an interpolated predicted image generated by performing, on a decoding side, motion vector estimation among a plurality of already decoded frames and performing interpolation based on the motion vector estimation.

5. The video decoding method according to claim 4, wherein
in the generation step, if all predicted images of the plurality of predetermined areas that are already decoded are the interpolated predicted images, the decoding process is performed using the interpolated predicted image as a predicted image of an area to be decoded.

6. The video decoding method according to claim 4, wherein
in the generation step, if all predicted images of the plurality of predetermined areas that are already decoded are predicted images generated by an intra prediction process or by an inter prediction process that uses motion information included in the coded stream, the decoding process is performed using the predicted image as a predicted image of an area to be decoded.

7. The video decoding method according to claim 4, wherein
in the generation step, the decoding process is performed with, of predicted images of the plurality of predetermined areas that are already decoded, a predicted image that is most frequently found as a predicted image of an area to be decoded.

8. A video decoding method for decoding a video signal, comprising:
an input step of inputting a coded stream;
a generation step in which, based on a determination as to whether or not a coding mode of an area within an already decoded frame that is temporally distinct from a frame in which an area to be decoded is present and that is located at the same coordinates as the area to be decoded is an intra prediction mode, it is determined per area whether a decoding process is to be performed using a predicted image generated by an intra prediction process or by an inter prediction process that uses motion information included in the coded stream, or the decoding process is to be performed using an interpolated predicted image generated by performing on a decoding side motion vector estimation among a plurality of frames that are already decoded and performing interpolation based on the motion vector estimation, the coded stream is decoded based on the determined predicted image, and decoded image data is generated; and
an output step of outputting the decoded image data.

9. The video decoding method according to claim 8, wherein in the generation step, if a result of the determination indicates intra prediction mode, the decoding process is performed using the interpolated predicted image.

10. The video decoding method according to claim 8, wherein
in the generation step,
if a result of the determination indicates that the coding mode is not intra prediction mode, a similarity degree is calculated, the similarity degree being information as to whether or not motion vector information of the area that is located at the same coordinates as the area to be decoded and motion vector information of an area adjacent to the area that is located at the same coordinates as the area to be decoded are similar,
if the similarity degree indicates similarity, the decoding process is performed using the predicted image generated by the intra prediction process or by the inter prediction process that uses the motion information included in the coded stream, and
if the similarity degree indicates dissimilarity, the decoding process is performed using the interpolated predicted image.

11. The video decoding method according to claim 1, wherein the similarity degree is a value based on a difference among motion vectors of already decoded areas that are adjacent to an area to be decoded.

12. The video decoding method according to claim 10, wherein the similarity degree is a value based on a difference between a motion vector of the area that is located at the same coordinates as the area to be decoded and a motion vector of the area that is adjacent to the area that is located at the same coordinates as the area to be decoded.

13. The video decoding method according to claim 1, wherein the similarity degree is a value based on variance of motion vectors of the plurality of predetermined areas that are already decoded.

14. The video decoding method according to claim 10, wherein the similarity degree is a value based on variance of a motion vector of the area that is located at the same coordinates as the area to be decoded and a motion vector of the area that is adjacent to the area that is located at the same coordinates as the area to be decoded.

15. The video decoding method according to claim 5, wherein
in the generation step, if all predicted images of the plurality of predetermined areas that are already decoded are predicted images generated by an intra prediction process or by an inter prediction process that uses motion information included in the coded stream, the decoding process is performed using the predicted image as a predicted image of an area to be decoded.

16. The video decoding method according to claim 5, wherein
in the generation step, the decoding process is performed with, of predicted images of the plurality of predetermined areas that are already decoded, a predicted image that is most frequently found as a predicted image of an area to be decoded.

17. The video decoding method according to claim 6, wherein
in the generation step, the decoding process is performed with, of predicted images of the plurality of predetermined areas that are already decoded, a predicted image that is most frequently found as a predicted image of an area to be decoded.

18. The video decoding method according to claim 2, wherein the similarity degree is a value based on variance of motion vectors of the plurality of predetermined areas that are already decoded.

19. The video decoding method according to claim 3, wherein the similarity degree is a value based on variance of motion vectors of the plurality of predetermined areas that are already decoded.
